(19) United States
(12) Patent Application Publication
(10) Pub. No.: US 2011/0125888 A1
(43) Pub. Date: May 26, 2011

(54) SYSTEM AND METHOD TO USE SERVICE CONTINUOUSLY BY USING HETEROGENEOUS TERMINALS

(75) Inventors: Jong Hwa Yi, Daejeon (KR); Shin Gak Kang, Daejeon (KR)

(73) Assignee: Electronics and Telecommunications Research Institute, Daejeon (KR)

(21) Appl. No.: 12/808,476

(22) PCT Filed: Dec. 17, 2008
(86) PCT No.: PCT/KR2008/007491

§ 371 Date: Jun. 16, 2010

(30) Foreign Application Priority Data
Dec. 17, 2007 (KR) 10-2007-0132736

(51) Int. Cl. G06F 15/173

(52) U.S. Cl. 709/223

(57) ABSTRACT

This invention provides a system and method to use continuously the same Internet services using different digital terminals even though user moves to another places. A system for providing Internet service using heterogeneous digital terminals includes a terminal registration/unregistration unit for registering and unregistering information on the digital terminals in and from an Internet service provider (ISP) server, a service management protocol unit for requesting the service from the ISP server, a terminal selection/change unit for selecting one of the registered digital terminals to use the service and reporting the selection to the ISP server, a content transmission/reception unit for receiving content service corresponding to the service request from the ISP server via the selected digital terminal, and a continuous-service preparation unit for preparing use of the service using a changed digital terminal.

### TECHNICAL FIELD

The present invention relates to a system and method for allowing a subscriber to continuously receive same Internet service using one of a plurality of available digital terminals at a current place or while in motion.

This work was supported by the IT R&D program of MIC/IITA [2007-P10-28, Standards Development for MoIP Applications and VoIP Interworking].

### BACKGROUND ART

As noted, a subscriber uses a variety of services on the Internet using a variety of digital terminals, including a notebook computer, a personal computer, a personal digital assistant (PDA), a digital television (TV), a mobile telephone, and a digital multimedia broadcasting (DMB). As a variety of digital terminals are introduced, the subscriber can choose a desired one of the terminals based on one's preference to receive Internet service.

FIG. 1 is a conceptual diagram illustrating a conventional system for providing Internet service. A subscriber receives desired Internet service from an Internet service provider (hereinafter, referred to as “ISP”) 2 using several types of digital terminals 1, including a personal computer, a notebook computer, a mobile telephone, a PDA, a digital TV, an Internet video telephone, and a DMB, and the ISP includes an application server and a content database (DB) for providing service or contents via the Internet S1.

The subscriber may use service to receive a great amount of information, such as contents on demand, using the notebook computer or the personal computer. The subscriber may also receive traffic information, digital broadcast contents, or satellite broadcast contents using the PDA or the DMB terminal with telematics in a moving car. The subscriber may also receive simple services anywhere and anytime, such as e-mail, and weather or bank information using the mobile telephone. The subscriber may also receive a variety of Internet services, as well as broadcast contents, using the digital TV at home.

In this case, the digital terminals have technical and environmental constraints for service. For example, the notebook computer or the personal computer has a large screen and provides high quality images for a great amount of information service (e.g., VOD service such as movie), but is difficult to use while in motion.

The DMB or the PDA allows the subscriber to use service in a moving car, but is not suitable for continuous services with a recent telematics or satellite technique.

The mobile telephone with high portability is costly for a great amount of information on the Internet, and provides limited services because of its relatively smaller screen.

As described above, the subscriber's digital terminals have different advantages and disadvantages for using Internet service.

Although the subscriber can use several types of digital terminals to receive Internet service, he or she cannot continuously receive the same service using the several types of digital terminals.

In an example, a subscriber receiving E-learning service using a personal computer at his or her work place must interrupt the service and access a service providing site again using another digital terminal (e.g., a PDA) in order to use the same service while in motion outside the work place. That is, the subscriber, when changed an environment or moved to another place, cannot use the same service continuously though he or she holds an available terminal.

In another example, a subscriber under video conference service with several persons using a notebook computer at a work place cannot take part in the video conference when the subscriber needs to move another place. In this case, the subscriber must use another terminal to take part in the video conference at another place after the subscriber moved to the place.

As described above, a subscriber cannot freely use the same service continuously using one of heterogeneous terminals selected depending on the subscriber's environment (e.g., at home, at a work place, or while in motion). That is, the subscriber cannot continuously use the same service due to temporal and spatial constraints.

### DISCLOSURE OF INVENTION

### Technical Problem

It is, therefore, an object of the present invention to provide a system and method for providing Internet service using heterogeneous terminals that allow a subscriber to use continuously the service freely from temporal and spatial constraints using one of available digital terminals selected depending on the subscriber's environment.

### Technical Solution

In accordance with a first aspect of the present invention, there is provided a system for providing Internet service using heterogeneous digital terminals, the system includes a terminal registration/unregistration unit for registering and unregistering information of the digital terminals in and from an Internet service provider (ISP) server, a service management protocol unit for sending a service request for a service to the ISP server, a terminal selection/change unit for selecting one of the registered digital terminals to use the service using the selected terminal, and reporting the selection to the ISP server, a content transmission/reception unit for receiving content service from the ISP server corresponding to the service request, and a continuous-service preparation unit for preparing the service to a changed digital terminal. The ISP server includes a subscriber management unit for storing information of the digital terminals, a content management unit for searching for the requested service to register the service for each subscriber and storing information of the selected digital terminal selected by the subscriber, a content transmission/reception unit for sending content service to the selected digital terminal when the selected digital terminal is normal, a subscriber-specific terminal management unit for, when a request for a terminal change is received from the selected digital terminal while the content service is being sent, continuously sending the content service to the changed digital terminal, and a terminal-specific content conversion unit for converting the content to be suitable for the selected digital terminal when the selected digital terminal is abnormal. When the request for the terminal change is not received from the selected digital terminal while the content service is being sent, the subscriber-specific terminal management unit continuously sends the content service to the selected digital terminal until a request for service termination is received. When a request for a terminal change is received, the terminal selection/change unit changes the selected terminal to another terminal of the registered digital terminals to use the service using said another terminal and reports the change to the ISP server. The content transmission/reception unit continuously receives the content service from the ISP server only in a continuous-service mode.

In accordance with a second aspect of the present invention, there is provided a method for providing Internet service using heterogeneous terminals, the method includes registering information of digital terminals in an ISP server, requesting a service to the ISP server, selecting one of the registered digital terminals to use the service using the selected digital terminal, and reporting the selection to the ISP server, receiving a content service, corresponding to the requested service, from the ISP server using the selected digital terminal, when a request for a terminal change is received, changing the terminal to another terminal of the registered digital terminals to use the service using said another terminal and sending a request to a terminal change to the ISP server. The method further includes storing information of the digital terminals, searching for the requested service and registering the same for each subscriber, storing information of the selected digital terminal selected by the subscriber, when the selected digital terminal is normal, sending the content service to the selected digital terminal, and when the request for the terminal change is received from the digital terminal while the content service is being sent, continuously sending the content service to said another digital terminal. The method further includes when the request for the terminal change is not received from the digital terminal while the content service is being sent, continuously transmitting the content service to the selected digital terminal until service termination is requested. The method further includes when the selected digital terminal is abnormal, converting the content to be suitable for the selected digital terminal and sending the converted content service to the selected digital terminal. The method further includes continuously receiving the content service from the ISP server using said another digital terminal only in a continuous-service mode.

### Advantageous Effects

When a subscriber use a service from ISP by a terminal on the internet, the present invention can provide an optimal environment for service use by allowing a subscriber to continuously use the service on the Internet even at another place or with another digital terminal.

That is, since the subscriber is allowed to freely use the same service using one of heterogeneous terminals selected depending on the subscriber's environment (e.g., at home, at work place, or while in motion), he or she can continuously use the same service freely from temporal and spatial constraints.

### BRIEF DESCRIPTION OF THE DRAWINGS

The above and other objects and features of the present invention will become apparent from the following description of preferred embodiments given in conjunction with the accompanying drawings, in which:

FIG. 1 is a conceptual block diagram of a conventional system for providing Internet service;

FIG. 2 is a conceptual diagram illustrating a system for providing Internet service using heterogeneous terminals according to the present invention;

FIG. 3 is a block diagram illustrating a system for providing Internet service using heterogeneous terminals according to a preferred embodiment of the present invention;

FIG. 4 is a flowchart illustrating operation of a terminal in a system for providing Internet service using heterogeneous terminals according to the present invention; and

FIG. 5 is a flowchart illustrating operation of an ISP server in a system for providing Internet service using heterogeneous terminals according to the present invention.

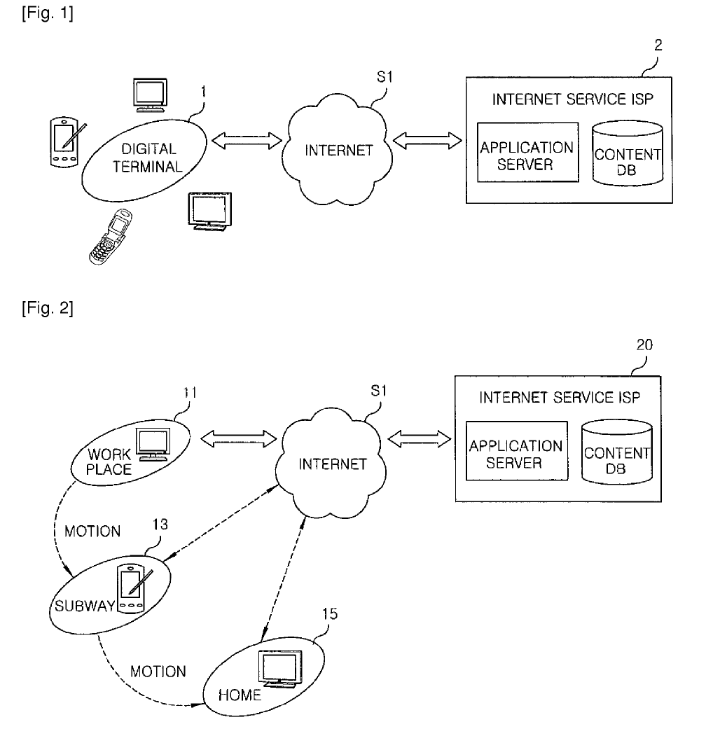

### BEST MODE FOR CARRYING OUT THE INVENTION

Hereinafter, a system and method for providing Internet service using heterogeneous terminals according to the present invention will be described in detail with reference to the accompanying drawings. Further, the following terms are defined in consideration of the functionality in the present invention, and may vary according to the intention of a user or an operator, usage, etc. Therefore, the definition should be made on the basis of the overall content of the present specification.

In the present invention, a subscriber registers information on all available digital terminals in an Internet service provider (ISP) and selects one of the registered terminals to receive desired service from the ISP.

Where the subscriber desires to move to another place or change a current terminal to another terminal for less charge or better service environment, such as computing power or image quality, during receiving desired service, the subscriber is allowed to select another one from the registered terminals.

That is, when the subscriber desires to continuously use the same service using another terminal, he or she sends information on the terminal to the ISP and selects the terminal to continuously use Internet service.

This process may be repeatedly performed, when needed, to allow the subscriber to continuously receive the same service at a work place or home, or while in motion.

FIG. 2 is a conceptual diagram illustrating a system for providing Internet service using heterogeneous terminals according to the present invention. A subscriber receives Internet service from an ISP 20 via the Internet S1, by using heterogeneous digital terminals while in motion.

When the subscriber, receiving a service using a personal computer 11 at a work place, selects a personal digital assistant (PDA) 13 among previously registered digital terminals and requests the same service from the ISP 20 before leaving the work place to receive the same service using the PDA 13, the subscriber is allowed to use the same service in a subway. When the subscriber arrives at home, selects a digital TV 15, which is more convenient to use the same service at home, and requests the service from the ISP 20 to receive the same service using the digital TV 15, the subscriber is allowed to continuously receive the service.

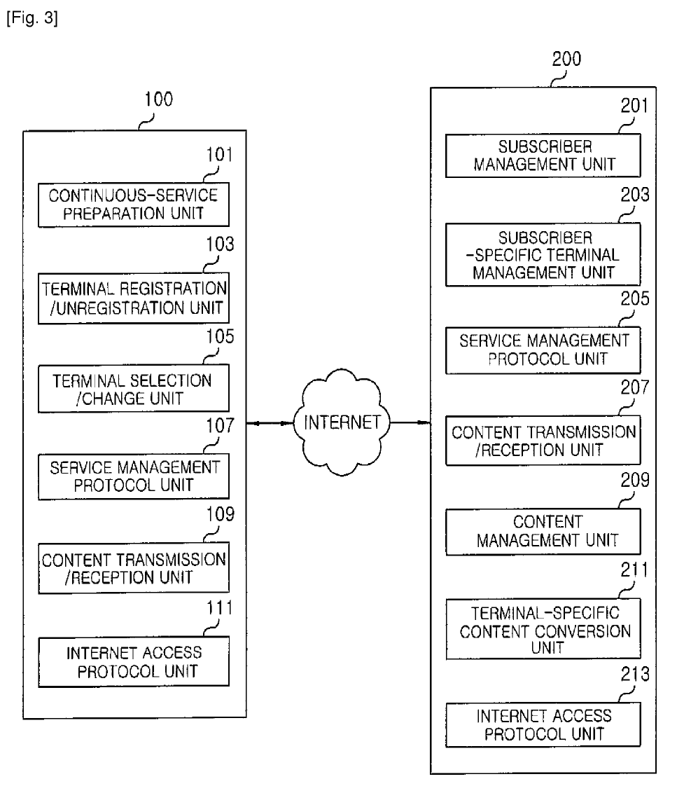

FIG. 3 is a block diagram illustrating a system for providing Internet service using heterogeneous terminals according to a preferred embodiment of the present invention. The system is a functional module that must be mounted on both a terminal 100 and an ISP server 200 for a subscriber to select one of heterogeneous terminals when needed and use service continuously.

The terminal 100 includes a continuous-service preparation unit 101 for processing a connection with the ISP server 200 and setting related environment to use continuous service, a terminal registration/unregistration unit 103 for registering or unregistering terminals to be used by a subscriber, a terminal selection/change unit 105 for selecting a specific terminal or changing a terminal for service use, a service management protocol unit 107 for requesting desired service and managing a service state (e.g., information on using terminal during using service), a content transmission/reception unit 109 for transmitting/receiving service or content data to/from the ISP server 200 via the Internet S1, and an Internet access protocol unit 111 for managing access to the Internet.

The ISP server 200 includes a subscriber management unit 201 for registering/un-registering subscribers, a subscriber-specific terminal management unit 203 for managing registration, unregistration, and a state (e.g., a terminal is in use or idle) of subscriber-specific terminals, a service management protocol unit 205 for managing a state of service for each subscriber and processing a connection with a new terminal selected by the subscriber when the subscriber select the new terminal, a content transmission/reception unit 207 for transmitting/receiving service or contents to/from the subscriber terminal 100, a content management unit 209 for managing, e.g., storing and deleting contents corresponding to the service, a terminal-specific content conversion unit 211 for converting the contents to be suitable for a terminal changed by the subscriber, and an Internet access protocol unit 213 for managing access to the Internet.

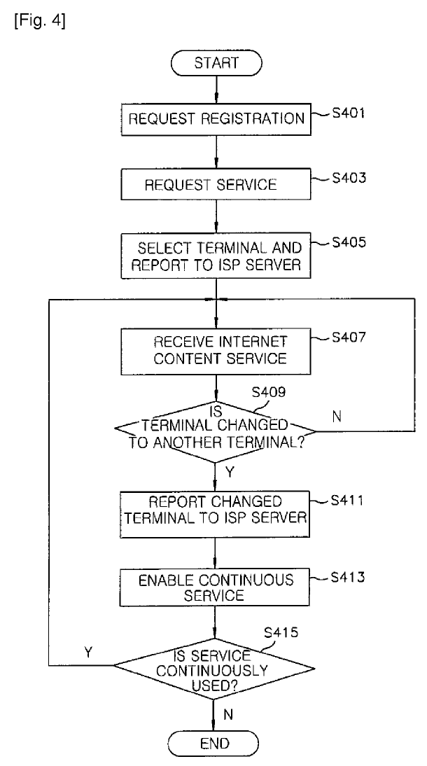

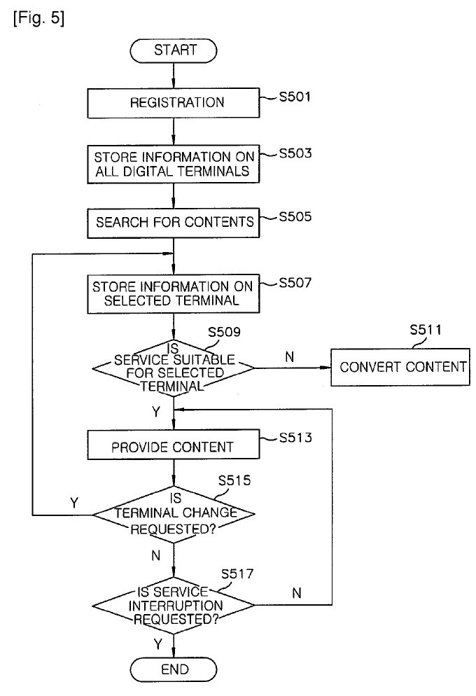

Operation of the system for providing Internet service using heterogeneous terminals configured as above will be described with reference to flowcharts of FIGS. 4 and 5.

FIG. 4 is a flowchart illustrating operation of the terminal 100 in the system for providing Internet service according to the present invention. FIG. 4 shows a process in which a subscriber requests a desired service and selects a preferred terminal to receive the service or changes the terminal to another terminal registered in the ISP server 200 to continuously receive the same service.

First, the subscriber registers information on all digital terminals in the ISP server 200 via the terminal registration/unregistration unit 103 (S401).

The subscriber then requests desired service from the ISP server 200 via the service management protocol unit 107 (S403), selects one of the registered terminal via the terminal selection/change unit 105, and reports the terminal selection to the ISP server 200 (S405).

The subscriber receives Internet service by receiving service or content data from the ISP server 200 via the content transmission/reception unit 109 using the terminal selected in step S405 (S407).

When the subscriber receiving the service desires to move to another place or change the current terminal to another terminal for less charge or better service environment, the subscriber determines whether to change the current terminal to another terminal via the terminal selection/change unit 105 (S409).

When it is determined in step S409 that the current terminal is to be changed to another terminal, the subscriber changes the current terminal to another terminal via the terminal selection/change unit 105 and reports the terminal change to the ISP server 200 (S411).

The subscriber then turns the terminal selected in step S411 on to enable the continuous-service preparation unit 101 (S413) and determines whether to continuously use the service (S415). When desiring to continuously use the service, the subscriber receives the service by receiving service or content data from the ISP server 200 via the content transmission/reception unit 109 using the new terminal, as in step S407.

FIG. 5 is a flowchart illustrating operation of the ISP server 200 in the system for providing Internet service by using heterogeneous terminals according to the present invention. FIG. 5 shows a process in which the ISP server 200 registers subscriber-specific services, registers or unregisters all terminals to be used by the subscriber, and processes a content suitable for the subscriber-selected terminal.

First, the ISP server 200 registers subscriber-specific services (S501).

The ISP server 200 then stores information on all digital terminals registered by the subscriber-specific terminal 100 in a database (DB) via subscriber-specific terminal management unit 203 (S503), and searches for service or contents stored by the content management unit 209 in order to provide subscriber-desired service (S505).

When the subscriber selects one of the registered terminals, the ISP server 200 stores information on the selected terminal (S507).

The ISP server 200 then determines whether the service to be provided is suitable for the selected terminal (S509).

When it is determined in step S509 that the service is not suitable, the ISP server 200 converts the content to be suitable for the selected terminal through the terminal-specific content conversion unit 211 (S511).

When it is determined in step S509 that the service to be provided is suitable for the selected terminal or when the content is converted to be suitable for the selected terminal in step S511, the ISP server 200 provides the content to the subscriber via the content transmission/reception unit 207 (S513).

The ISP server 200 then determines whether the subscriber requests a change to another terminal via the subscriber-specific terminal management unit 203 (S515).

When it is determined in step S515 that the subscriber requests the change to another terminal, the ISP server 200 proceeds to step S507. On the other hand, when it is determined in step S515 that the subscriber does not request the change to another terminal, the ISP server 200 determines whether the subscriber requests service interruption (S517). The ISP server 200 proceeds to step S513 until the subscriber requests service interruption, and continuously provides desired service or contents to the subscriber.

Thus, according to the present invention, when the subscriber receives the service from the ISP using the terminal on the Internet, he or she is allowed to continuously use the same service using a suitable terminal though the subscriber move to another places or changes the terminal to another terminal. This provides an optimal environment for service use to the subscriber.

While the invention has been shown and described with respect to the embodiments, it will be understood by those skilled in the art that various changes and modifications may be made without departing from the scope of the invention as defined in the following claims.

1. A system for providing Internet service using heterogeneous digital terminals, the system comprising:
a terminal registration/unregistration unit for registering and unregistering information of the digital terminals in and from an Internet service provider (ISP) server;
a service management protocol unit for sending a service request for a service to the ISP server;
a terminal selection/change unit for selecting one of the registered digital terminals to use the service using the selected terminal, and reporting the selection to the ISP server;
a content transmission/reception unit for receiving content service, corresponding to the service request, from the ISP server; and
a continuous-service preparation unit for preparing the service to a changed digital terminal.

2. The system of claim 1, wherein the ISP server comprises:
a subscriber management unit for storing information of the digital terminals;
a content management unit for searching for the requested service to register the service for each subscriber and storing information of the selected digital terminal selected by the subscriber;
a content transmission/reception unit for sending content service to the selected digital terminal when the selected digital terminal is normal;
a subscriber-specific terminal management unit for, when a request for a terminal change is received from the selected digital terminal while the content service is being sent, continuously sending the content service to the changed digital terminal; and
a terminal-specific content conversion unit for converting the content to be suitable for the selected digital terminal when the selected digital terminal is abnormal.

3. The system of claim 2, wherein, when the request for the terminal change is not received from the selected digital terminal while the content service is being sent, the subscriber-specific terminal management unit continuously sends the content service to the selected digital terminal until a request for service termination is received.

4. The system of claim 1, wherein when a request for a terminal change is received, the terminal selection/change unit changes the selected terminal to another terminal of the registered digital terminals to use the service using said another terminal and reports the change to the ISP server.

5. The system of claim 1, wherein the content transmission/reception unit continuously receives the content service from the ISP server only in a continuous-service mode.

6. A method for providing Internet service using heterogeneous terminals, the method comprising:
registering information of digital terminals in an ISP server;
requesting a service to the ISP server, selecting one of the registered digital terminals to use the service using the selected digital terminal, and reporting the selection to the ISP server;
receiving a content service, corresponding to the requested service, from the ISP server using the selected digital terminal;
when a request for a terminal change is received, changing the terminal to another terminal of the registered digital terminals to use the service using said another terminal and sending a request to a terminal change to the ISP server.

7. The method of claim 6, further comprising:
storing information of the digital terminals;
searching for the requested service and registering the same for each subscriber;
storing information of the selected digital terminal selected by the subscriber;
when the selected digital terminal is normal, sending the content service to the selected digital terminal; and
when the request for the terminal change is received from the digital terminal while the content service is being sent, continuously sending the content service to said another digital terminal.

8. The method of claim 7, further comprising, when the request for the terminal change is not received from the digital terminal while the content service is being sent, continuously transmitting the content service to the selected digital terminal until service termination is requested.

9. The method of claim 7, further comprising, when the selected digital terminal is abnormal, converting the content to be suitable for the selected digital terminal and sending the converted content service to the selected digital terminal.

10. The method of claim 6, further comprising, continuously receiving the content service from the ISP server using said another digital terminal only in a continuous-service mode.
